(19) United States
(12) Patent Application Publication
(10) Pub. No.: US 2026/0305614 A1
(43) Pub. Date: Oct. 8, 2026

(54) An Anti-Soiling, Self-Cleaning, and Antimicrobial Coating for Disinfecting Surface

(71) Applicant: Nanoveu PTE LTD, Singapore (SG)

(72) Inventor: Ah Eng SIAW, Johor Bahru, Johor (MY)

(21) Appl. No.: 19/484,655

(22) PCT Filed: May 15, 2023
(86) PCT No.: PCT/MY2023/050037

§ 371 Date: Nov. 14, 2025

(51) Int. Cl. A01N 59/20; A01N 59/16; A01P 1/00; C09D 5/14; C09D 7/61

(52) U.S. Cl. CPC A01N 59/20; A01N 59/16; A01P 1/00; C09D 5/14; C09D 7/61

(57) ABSTRACT

A coating composition for disinfecting surface and a method of preparation thereof are disclosed. Particularly, the coating composition comprises a nano-sized metal oxide selected from the group consisting of silver oxide, copper oxide, gold oxide, and any combination thereof, at least one ultraviolet or fluorescent light-assisted photocatalyst, and an anti-static agent selected from antimony-doped tin oxide, quaternary ammonium salt, aliphatic amine, aliphatic amide, ester, or polyol.

### FIELD OF INVENTION

The invention relates to an anti-soiling, self-cleaning, and antimicrobial coating for disinfecting surface. Particularly, a composition of the anti-soiling, self-cleaning, and antimicrobial coating and method of preparation thereof are provided herein.

### BACKGROUND OF THE INVENTION

An emerging antimicrobial surface treatment technology is based on photocatalytic oxidation that converts fine particles and toxic gases into safer compounds. Basically, a photocatalytic surface treatment includes the use of a photocatalyst which reacts with broad spectrum ultraviolet light to create hydroxyl radicals and super-oxide ions for oxidizing volatile organic compounds and eliminating microorganisms adsorbed on the catalyst surface.

Examples of photocatalyst commonly used as disinfectant for surface treatment include titanium oxide, titanium dioxide, zinc oxide, tungsten oxide and tungsten trioxide. By bombarding the photocatalyst with lights of certain wavelengths, electrons in the material's valence band are excited into the conduction band. As a result, the electrons are free to move and their energy can be utilized to split up nearby water and oxygen molecules into hydroxyl radicals and super-oxide ions.

Hydroxyl radicals are among the most powerful oxidizers and stronger than chlorine, ozone and peroxide but consequently the radicals are very short lived. The oxidizers can break the bonds of organic substances such as germs and volatile organic molecules into smaller compounds until only carbon dioxide and water vapor are left.

Furthermore, activated photocatalyst have shown to be capable of killing a wide range of Gram-negative and Gram-positive bacteria, filamentous and unicellular fungi, algae, protozoa, mammalian viruses and bacteriophage. However, resting stages, particularly bacterial endospores, fungal spores and protozoan cysts, are generally more resistant to photocatalytic killing than the vegetative forms, possibly due to the increased cell wall thickness. For instance, Acanthamoeba cysts and Trichoderma asperellum have been reported to be resistant to photocatalysis.

One improvement on photocatalytic disinfection technology includes the addition of other elements. Some examples of the elements are vanadium, copper, zinc, rhodium, silver and nickel. Great attention has been focused on using nano-silver and nano-copper particles in a coating for disinfecting the surface. It has been examined that silver and copper can provide natural anti-bacterial, anti-viral and anti-fungal benefits. When the nano-silver particles come into contact with a bacteria or virus, they suppress the cell's nutrient transport, attack the cell membrane and interfere with cell division to hinder the reproduction of the germs. Nano-copper particles, on the other hand, damage bacterial cell membranes or “envelopes” and can destroy the DNA or RNA of the microbe. Nano-copper particles generate oxidative stress on bacterial cells and create hydrogen peroxide that can kill the cells. They also interfere with proteins that play vital functions.

The invention provides an improved photocatalytic disinfection technique, a composition therefor and a method of preparing the composition.

### SUMMARY OF THE INVENTION

The primary object of the invention is to provide a coating composition for disinfecting a surface effectively by eliminating a variety of organic contaminants and microorganisms within a short period of time.

At least one of the preceding objects is met, in whole or in part, by the invention, in which the embodiment of the invention describes a coating composition comprising a nano-sized metal oxide selected from the group consisting of silver oxide, copper oxide, gold oxide, and any combination thereof; at least one ultraviolet or fluorescent light-assisted photocatalyst; and an anti-static agent selected from antimony-doped tin oxide, quaternary ammonium salt, aliphatic amine, aliphatic amide, ester, or polyol.

In a preferred embodiment of the invention, the coating composition further comprises a binder, a liquid carrier, a surface additive, or any combination thereof.

In a preferred embodiment of the invention, the coating composition comprises from 0.01% to 5.0% by weight of the nano-sized metal oxide.

In a preferred embodiment of the invention, the nano-sized metal oxide has a particle size ranging from 5 nm to 50 nm.

In a preferred embodiment of the invention, the coating composition comprises 0.01% to 30.0% by weight of the ultraviolet or fluorescent light-assisted photocatalyst.

In a preferred embodiment of the invention, the anti-static agent is antimony-doped tin oxide, quaternary ammonium salt, aliphatic amine, aliphatic amide, ester, or polyol.

The invention further describes an article formed from the coating composition and a substrate made of glass, metal, plastic, porcelain, rubber, paper, fabric, and any two or more of the combination thereof.

### BRIEF DESCRIPTION OF THE DRAWINGS

For the purpose of facilitating an understanding of the invention, there is illustrated in the accompanying drawings the preferred embodiments from an inspection of which when considered in connection with the following description, the invention, its construction and operation and many of its advantages will be readily understood and appreciated.

FIG. 1 is an agarose gel electrophoresis image of reverse transcription polymerase chain reaction (RT-PCR) products of the test samples described in Example 1.

FIG. 2 is an agarose gel electrophoresis image of reverse transcription polymerase chain reaction (RT-PCR) products of the test samples described in Example 2.

FIG. 3 is an agarose gel electrophoresis image of reverse transcription polymerase chain reaction (RT-PCR) products of the test samples described in Example 3.

### DETAILED DESCRIPTION OF THE INVENTION

One skilled in the art will readily appreciate that the invention is well adapted to carry out the objects and obtain the ends and advantages mentioned, as well as those inherent therein. The embodiment described herein is not intended as limitations on the scope of the invention.

The invention discloses a coating composition for disinfecting purposes, including but not limiting to surface disinfection. Particularly, the coating composition disclosed herein is an anti-soiling, self-cleaning, and antimicrobial coating composition having at least one nano-sized metal oxide, at least one ultraviolet or fluorescent light-assisted photocatalyst, and an anti-static agent. It is preferable to apply the coating composition as a coating over a surface for effective removal of organic contaminants and inhibition of microbial growth on the surface. Particularly, the coating composition can be applied onto surface of a substrate made of glass, metal, plastic, porcelain, rubber, paper, fabric, and any two or more of the combination thereof. The coating composition disclosed herein is effective against a broad range of microorganisms including viruses and bacteria.

In the preferred embodiment of the invention, the coating composition comprises at least one metal oxide selected from the group consisting of silver oxide, copper oxide, gold oxide, and any combination thereof. These metal oxides are capable of slowing or hindering microbial growth and/or inactivating or killing microbes. Preferably, these metal oxides are in the form of nano-sized particles. One skilled in the art shall not limit the metal oxide to one type of metal oxide; rather it can be a mixture of two or more types of metal oxide. In a more preferred embodiment, the coating composition at least comprises nano-sized silver oxide, copper oxide, gold oxide, or any combination thereof.

Silver oxide is particularly preferred over other metal oxides as silver efficiently inactivates microbes. Nano-silver particles which come in contact with bacteria and fungi can adversely affect the cellular metabolism of these microorganisms by suppressing their cellular respiration, basal metabolism of electron transfer system and transport of substrate in the microbial cell membrane. As a result, the nano-silver particles are able to inhibit multiplication and growth of the contacted bacteria and fungi which may cause infection, odor, itchiness and sores.

Similarly, copper oxide is preferred as copper is able to efficiently inactivate microorganism. Nano-copper particles are capable of killing microorganisms such as bacteria and viruses. Nano-copper particles damage microbial cell membranes or envelopes and destroy microbial DNA or RNA. The antimicrobial activity of nano-copper particles is attributed to their ability to generate oxidative stress on bacterial cells and create hydrogen peroxide that can kill the microbe. Furthermore, nano-copper particles interfere with proteins that are responsible for vital cellular functions or processes in the microbial cells.

In the preferred embodiment of the invention, the coating composition comprises 0.01% to 30.0% by weight of the nano-sized metal oxide.

It is important that the metal oxide particles in the coating composition are in the nano-sized range so as to provide bigger surface area for contact with microorganisms as compared to common micro-sized metal oxide particles. In an exemplary embodiment of the invention, 1 gram of 10 nm silver oxide particles provide a contact surface area of approximately 100 m². Preferably, the metal oxide particles in the coating composition are 5 nm to 100 nm in size.

Pursuant to the preferred embodiment of the invention, the coating composition comprises at least one ultraviolet light-assisted photocatalyst selected from the group consisting of titanium oxide, titanium dioxide, tungsten oxide, tungsten trioxide, zinc oxide, and any combination thereof. The ultraviolet light-assisted photocatalyst is responsive to an ultraviolet or fluorescent light source to oxidize viruses, bacteria, mold, fungi, odor, volatile organic compounds and toxic gases. Preferably, the coating composition comprises 0.01% to 30.0% by weight of an ultraviolet light-assisted photocatalyst.

Photocatalysis is initiated when ultraviolet light-assisted photocatalyst in the coating composition is exposed to ultraviolet or fluorescent light rays. This is known as an optical solid surface or interface reaction. Upon activation of the photocatalyst, a repetitive oxidation-reduction (redox) reaction occurs at the surface of the ultraviolet light-assisted photocatalyst. Air containing oxygen and water vapor is required for the redox reaction.

During the photocatalysis process, the photocatalyst absorbs ultraviolet or fluorescent rays to generate electrons and positive-charged holes. The greater the generation of electrons (e) and positive-charged holes (h⁺), the higher the reaction effect is. The reaction of photocatalysis is shown as below:

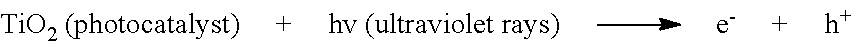

The generated positive holes have strong oxidization ability and by reacting with water molecules present on the surface of the photocatalyst, hydroxyl radicals (.OH) can be generated. The hydroxyl radicals are generated through a reaction as shown below:

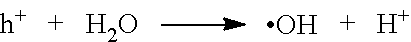

The generated hydroxyl radicals oxidize organic contaminant compounds. In the presence of oxygen, radicals of the intermediates of organic contaminant compounds induce a radical chain reaction and consume oxygen. As a results, the organic contaminants compounds are decomposed and eventually turn into carbon dioxide and water.

On the other hand, the generated electrons produce superoxide anions (O₂⁻) by causing a reductive reaction with oxygen on the surface of the photocatalyst, in which the reaction is shown as below:

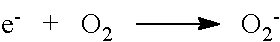

The superoxide anions form oxides by adhering to the intermediates of the oxidation reaction or turn into hydrogen peroxide (H₂O₂) and then into water. Free oxygen radical (—O) is also generated in the air and directly affects the carbon-carbon bond of organic matter.

Since organic matter is usually more oxidizable than water, therefore the positive-charged holes are more likely to oxidize the organic compounds. The recombination rate of both carriers, which are the holes and electrons, shall decrease when the concentration of organic matter is higher.

In the present invention, hydrophilicity or hydrophobicity of the coating composition can be varied based on the proportion of the nano-sized metal oxide and the ultraviolet or fluorescent light-assisted photocatalyst. In particular, the nano-sized metal oxide is hydrophobic in nature, whereas the ultraviolet or fluorescent light-assisted photocatalyst is hydrophilic in nature. Therefore, a coating composition that is more hydrophobic can be produced by increasing proportion of the nano-sized metal oxide, whereas a coating composition that is more hydrophilic can be produced by increasing proportion of the ultraviolet or fluorescent light-assisted photocatalyst. Advantageously, this allows the coating composition to be optimized based on the intended use. For example, the more hydrophobic coating composition can be applied onto a top inclined surface of a solar panel to form a water-repelling layer. When the water-repelling layer comes into contact with water, the water-repelling layer causes the water on it to form into droplets and subsequently roll across the top inclined surface while simultaneously removing contaminants, such as soil, along its path. This creates “anti-soiling” and “self-cleaning” effects in which the soil will be automatically removed by the water without the need of additional cleaning process. On the other hand, the more hydrophilic coating composition can be applied onto the top inclined surface such that a thin water layer is formed upon coming into contact with water. The thin water layer will form between the top inclined surface and the contaminants, thereby creating a wet layer therebetween. The wet layer prevents the contaminants to dry off, which eases the removal of the contaminants. Advantageously, the wet layer allows the contaminants to be easily removed from the top inclined surface during event such as raining.

By way of example, the more hydrophobic coating composition can include 0.1% to 5% by weight of nano-sized metal oxide and 0.05% to 0.5% by weight of ultraviolet or fluorescent light-assisted photocatalyst. On the other hand, the more hydrophilic coating composition can include 0.01% to 0.05% by weight of nano-sized metal oxide and 0.1% to 2% by weight of ultraviolet or fluorescent light-assisted photocatalyst.

Preferably, the coating composition comprises 0.01% to 30% by weight of anti-static agent. More preferably, the coating composition comprises 0.1% to 2% by weight of anti-static agent. Preferably, the anti-static agent is antimony-doped tin oxide, quaternary ammonium salt, aliphatic amine, aliphatic amide, ester, or polyol. By way of example, the quaternary ammonium salt is behentrimonium chloride or cocamidopropyl bentaine. On the other hand, the ester can be phosphate ester, polyethylene glycol ester, or ester of phosphoric acid, whereas the polyol can be ethylene glycol. Advantageously, the anti-static agent in the coating composition can reduce amount or prevent accumulation of static electricity on the surface where the coating composition is applied. Static electricity is undesired because it can attract small particles such as dust or soil to stick onto the surface, thereby adversely affecting aesthetic of the surface or reducing performance of certain electronic devices, such as solar panel. Overall, the nano-sized metal oxide, ultraviolet or fluorescent light-assisted photocatalyst, and the anti-static agent in the coating composition can improve or maintain cleanliness of the surface where the coating composition is applied.

The coating composition disclosed herein may further comprise a liquid carrier which is a solvent-based or water-based. Particularly, the particles of metal oxide are contained within a liquid carrier so that the coating composition is readily to be applied and coated on a surface. Any kind of liquid carrier which does not react with the metal oxide can be used. Preferably, the liquid carrier is a silicone oil or an alcohol or a water or a mixture thereof. More preferably, the alcohol can be selected from isopropanol, methanol, or ethanol, whilst the silicone oil can be selected from hexamethyl disiloxane, octamethyl trisiloxane, decamethylcyclo pentasiloxane, polydimethyl siloxane or octamethylcyclo tetrasiloxane. When a surface is coated with the coating composition, the presence of silicone oil also provides the surface with a smooth appearance as well as anti-stick characteristics so that dust or other solid impurities will not adhere to the surface. Preferably, the coating composition comprises 75% to 94% by weight of liquid carrier. The silicone oil and alcohol are hydrophobic in nature. Therefore, these are preferably used when the coating composition that is more hydrophobic is desired. On the other hand, the water is preferably used when the coating composition that is more hydrophilic is desired.

The coating composition disclosed herein may further comprise a binder. A binder is needed to ensure the coating binds well to the surface to be coated. Preferably, the binder is a silane or monopolymer or copolymer. More preferably, the silane is an alkyl silane. The alkyl silane can be selected from methyl silane, dimethydiethoxysilane, tetraethoxysilane, linear dialkylsilane, fluorinated alkyl silane, or cyclic alkylsilane. Any silane binder which can render the coating composition be cured at room temperature and reduced curing time can be used. Preferably, the coating composition comprises 0.01% to 30% by weight of binder.

In addition to the carrier and binder, the coating composition disclosed herein may further comprise a surface additive. Surface additive is added to further enhance binding of the coating to the surface to be coated. Preferably, the surface additive is an acid to decrease the pH of the coating composition. When the coating composition is coated on the surface, the acidic coating composition may slightly etch the surface and form bonds between the coating composition and the surface. It shall be noted that the amount of acid added shall not be high to the extent that the pH of the coating composition falls below 5 or become strongly acidic. It is preferred that the coating composition has a pH ranging from 5 to 6 which effectively enhance binding of the coating without causing any corrosion to any part of the device. Preferably, the acid can be selected from sulphuric acid, phosphoric acid, nitric acid, or hydrochloric acid. An alkaline coating composition is not preferred as it may render the coating to be easily detached from the surface. Preferably, the coating composition comprises 0.1% to 8% by weight of surface additive. More preferably, the coating composition comprises less than 2% by weight of surface additive.

The coating composition described in any of the preceding description can be produced with the following method. Components of the coating composition such as metal oxide, ultraviolet or fluorescent light-assisted photocatalyst, anti-static agent, binder, liquid carrier, and surface additive are homogeneously mixed one at a time. The order of mixing is preferred to be binder, surface additive, liquid carrier, anti-static agent, metal oxide, and ultraviolet or fluorescent light-assisted photocatalyst. It shall be noted that metal oxide shall not be added before silane or mono-polymer or copolymer in order to achieve a homogeneous mixture. More preferably, the coating composition is homogenised by an ultrasonic mixer operating at a frequency of 20 kHz to 100 kHz for at least 1 hour. However, it is not necessary to mix the coating composition for more than 2 hours to achieve a homogeneous mixture. Any other method of homogenising the mixture can be adopted. During the homogenisation, nano particulates metal oxide can be further broken down into smaller size with a higher surface area.

The present invention further describes an article formed from the coating composition and a substrate made of glass, metal, plastic, porcelain, rubber, paper, fabric, and any two or more of the combination thereof. For example, the substrate can be a solar panel.

Although the invention has been described and illustrated in detail, it is to be understood that the same is by the way of illustration and example, and is not to be taken by way of limitation. The scope of the invention are to be limited only by the terms of the appended claims.

### EXAMPLES

Examples are provided below to illustrate different aspects and embodiments of the invention. The examples are not intended in any way to limit the disclosed invention, which is limited only by the claims.

### Example 1

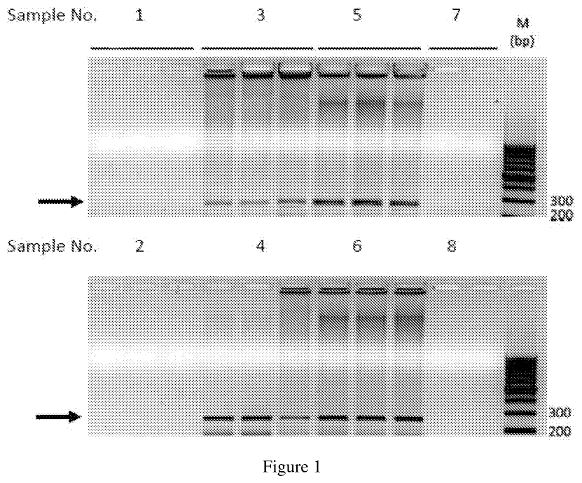

Evaluation of the antimicrobial effect of the disclosed coating composition against Coronavirus 043 (CoV-O43) 8 test samples are prepared in triplicate according to Table 1. The test virus being used for the test is Coronavirus 043 (CoV-O43). Concentration of the test virus in each sample is 104 pfu/ml. The volume ratio of the coating composition to the test virus in samples no. 1 and 2 is 3:1. The test samples are kept at appropriate temperature for the duration of contact time specified in Table 1. Samples no. 1 to 4 are exposed to white/visible light whereas samples no. 5 to 8 are not subjected to any light exposure during the specified contact time. Immediately after the specified contact time, the test samples are subjected to viral nucleotide extraction and a pan-coronavirus reverse transcription polymerase chain reaction (RT-PCR) assay for detection of test virus in the test samples. The PCR products of each test sample are subjected to agarose gel electrophoresis. Presence of PCR product of 251 bp in the agarose gel indicates presence of test virus in the test sample. The test results are shown in Table 1 and FIG. 1.

TABLE 1

| | | | Duration of | Detection |
|---|---|---|---|---|
| | | Visible | contact time | of PCR |
| Sample | | light | with test virus | product of |
| No. | Sample content | Exposure | (mins) | 251 bp |
| 1 | Test virus, | Yes | 5 | No |
| 2 | Coating composition | Yes | 60 | No |
| 3 | Test virus | Yes | 5 | Yes |
| 4 | | Yes | 60 | Yes |
| 5 | Test virus | No | 5 | Yes |
| 6 | (Positve control) | No | 60 | Yes |
| 7 | Empty | No | 5 | No |
| 8 | (Negative control) | No | 60 | No |

Refer to Table 1 and FIG. 1, no PCR product of 251 bp is detected in both samples no. 1 and 2, indicating the test virus (Coronavirus 043, CoV-O43) and its viral RNA in these samples are efficiently degraded by the coating composition disclosed herein. Furthermore, the test results show that the coating composition is effective against CoV-O43 after a period as short as 5 mins. Therefore, a quick surface disinfecting effect can be achieved by using the coating composition disclosed herein.

### Example 2

Evaluation of the antimicrobial effect of the disclosed coating composition against Enterovirus A71 (EV-A71)

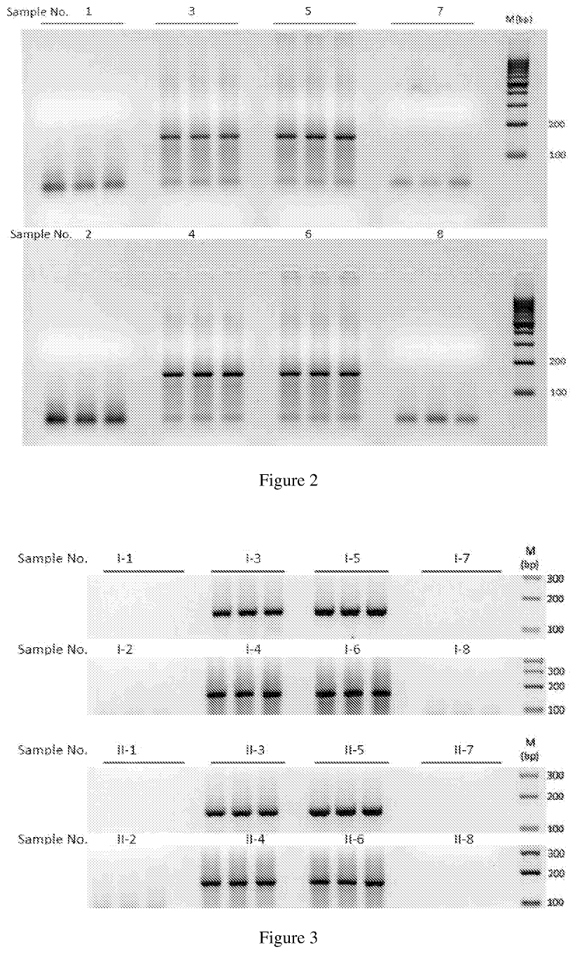

8 test samples are prepared in triplicate according to Table 2. The test virus being used for the test is Enterovirus A71 (EV-A71). Concentration of the test virus in each sample is 105 pfu/ml. The volume ratio of the coating composition to the test virus in samples no. 1 and 2 is 3:1. The test samples are kept at appropriate temperature for the duration of contact time specified in Table 2. Samples no. 1 to 4 are exposed to white/visible light whereas samples no. 5 to 8 are not subjected to any light exposure during the specified contact time. Immediately after the specified contact time, the test samples are subjected to viral nucleotide extraction and a pan-enterovirus reverse transcription polymerase chain reaction (RT-PCR) assay for detection of test virus in the test samples. The PCR products of each test sample are subjected to agarose gel electrophoresis. Presence of PCR product of 154 bp in the agarose gel indicates presence of test virus in the test sample. The test results are shown in Table 2 and FIG. 2.

TABLE 2

| | | | Duration of | Detection |
|---|---|---|---|---|
| | | Visible | contact time | of PCR |
| Sample | | light | with test virus | product of |
| No. | Sample content | Exposure | (mins) | 154 bp |
| 1 | Test virus, | Yes | 5 | No |
| 2 | Coating composition | Yes | 60 | No |
| 3 | Test virus | Yes | 5 | Yes |
| 4 | | Yes | 60 | Yes |
| 5 | Test virus | No | 5 | Yes |
| 6 | (Positve control) | No | 60 | Yes |
| 7 | Empty | No | 5 | No |
| 8 | (Negative control) | No | 60 | No |

Refer to Table 2 and FIG. 2, no PCR product of 154 bp is detected in both samples no. 1 and 2, indicating the test virus (Enterovirus A71, EV-A71) and its viral RNA in these samples are efficiently degraded by the coating composition disclosed herein. Furthermore, the test results show that the coating composition is effective against EV-A71 after a period as short as 5 mins. Therefore, a quick surface disinfecting effect can be achieved by using the coating composition disclosed herein.

### Example 3

Evaluation of the antimicrobial effect of the disclosed coating composition against Coxsackievirus A6 (CVA-6) and Coxsackievirus A16 (CVA-16)

Two sets of 8 test samples are prepared in triplicate according to Table 3. The test virus being used in the first set (Set I) of test samples is Coxsackievirus A6 (CVA-6) while the one being used in the second set (Set II) of test samples is Coxsackievirus A16 (CVA-16). Concentration of the test virus in each sample is 10⁵ pfu/ml. The volume ratio of the coating composition to the test virus in samples no. I-1, I-2, II-1 and II-2 is 3:1. The test samples are kept at appropriate temperature for the duration of contact time specified in Table 3. In each set I and II, samples no. 1 to 4 are exposed to white/visible light whereas samples no. 5 to 8 are not subjected to any light exposure during the specified contact time. Immediately after the specified contact time, the test samples are subjected to viral nucleotide extraction and a pan-enterovirus reverse transcription polymerase chain reaction (RT-PCR) assay for detection of test virus in the test samples. The PCR products of each test sample are subjected to agarose gel electrophoresis. Presence of PCR product of 154 bp in the agarose gel indicates presence of test virus in the test sample. The test results are shown in Table 3 and FIG. 3.

TABLE 3

| | | | | Duration | |
|---|---|---|---|---|---|
| | | | | of contact | Detection |
| | | | Visible | time with | of PCR |
| | Sample | | light | test virus | product |
| Set | No. | Sample content | Exposure | (mins) | of 154 bp |
| I | 1 | Test virus (CVA-6), | Yes | 5 | No |
| | 2 | Coating | Yes | 60 | No |
| | | composition | | | |
| | 3 | Test virus (CVA-6) | Yes | 5 | Yes |
| | 4 | | Yes | 60 | Yes |
| | 5 | Test virus (CVA-6) | No | 5 | Yes |
| | 6 | (Positive control) | No | 60 | Yes |
| | 7 | Empty | No | 5 | No |
| | 8 | (Negative control) | No | 60 | No |
| II | 1 | Test virus (CVA-16), | Yes | 5 | No |
| | 2 | Coating | Yes | 60 | No |
| | | composition | | | |
| | 3 | Test virus (CVA-16) | Yes | 5 | Yes |
| | 4 | | Yes | 60 | Yes |
| | 5 | Test virus (CVA-16) | No | 5 | Yes |
| | 6 | (Positve control) | No | 60 | Yes |
| | 7 | Empty | No | 5 | No |
| | 8 | (Negative control) | No | 60 | No |

Refer to Table 3 and FIG. 3, no PCR product of 154 bp is detected in the samples no. I-1, I-2, II-1 and II-2, indicating the test viruses (Coxsackievirus A6, CVA-6 and Coxsackievirus A16, CVA-16) and their viral RNA in these samples are efficiently degraded by the coating composition disclosed herein. Furthermore, the test results show that the coating composition is effective against CVA-6 and CVA-16 after a period as short as 5 mins. Therefore, a quick surface disinfecting effect can be achieved by using the coating composition disclosed herein.

### Example 4

Efficacy test of the disclosed coating composition against severe acute respiratory syndrome coronavirus 2 (SARS-COV-2) responsible for coronavirus disease 2019 (COVID-19)

### Cells and Viruses

The test virus, severe acute respiratory syndrome coronavirus 2 (SARS-COV-2), was isolated, propagated and maintained in Vero E6 cells at Tropical Infectious Diseases Research and Education Center (TIDREC), University of Malaya, Malaysia. The Vero E6 cells were cultured in Dulbecco's Modified Eagle Medium (DMEM) (Gibco, Grand Island, New York, USA) supplemented with 10% fetal bovine serum (FBS). The cells were maintained at 37° C. with 5% carbon dioxide (CO₂). Viral titers were determined by microtitration using the Vero E6 cells and expressed in tissue culture infectious dose 50% (TCID₅₀/mL). When cytopathic effects (CPE) were evident under the microscope, the supernatant was harvested, clarified by centrifugation and stored at −80° C. until needed.

### In Vitro Quantitative Suspension Assay

A coating composition comprising titanium dioxide, silver ions and copper ions as active ingredients (test product A) and a coating composition comprising copper ions as active ingredients (test product B) were tested against the test virus in accordance to the European Standard EN14476:2013/FprA1:2015 protocol. The experimental conditions are shown in Table 4. Test product A and test product B were tested undiluted and at a 2-fold dilution under two different conditions, namely dirty condition (3.0 g/l bovine serum albumin (BSA)+3 ml/l erythrocytes interfering substance) and clean condition (0.3 g/l BSA interfering substance), at 1 min, 5 min and 10 min contact time. The test mixtures comprised of 100 μl of interfering substance, 100 μl of virus suspension at concentration of 5.42×10⁵ TCID₅₀/mL, and 100 μl of test product A or 800 μl of test product B. After the specified contact time (1 min, 5 min and 10 min), virucidal activities of the test products were immediately suppressed by adding DMEM+2% FBS to the test mixtures and then the mixtures were diluted in 10 fold in ice-cold media (DMEM+2% FBS). The diluted test mixtures were added to the Vero E6 cells to determine TCID₅₀/mL. A virus control mixture was also assessed using distilled water in place of the test products for both dirty and clean conditions. The cells were incubated for 72 hours till the CPE developed. A mixture of paraformaldehyde and crystal violet was used to fix and stain the infected cells. The viral titers were determined using the Spearman-Karber method and expressed as tissue culture infectious dose 50% (TCID₅₀/mL). The virucidal activities of test product A and test product B were determined by the difference of the logarithmic titer of the virus control minus the logarithmic titer of the test virus (Δ log 10 TCID₅₀/mL). A reduction in viral titer of 4 log₁₀ (corresponding to an inactivation of ≥99.99%) was necessary for claiming virucidal activity of the test products.

TABLE 4

| | |
|---|---|
| Test temperature | 21.0° C. ± 1° C. |
| Test product's active | Test product A: titanium dioxide, silver ion and |
| ingredient(s) | copper ion |
| | Test product B: copper ion |
| Test product | Test product A: 5% |
| concentration | Test product B: 2% |
| Contact times | Contact time: 1 min, 5 min and 10 min |
| | Coated: 2 hour (Post-application) |
| Conditions | Clean condition: 0.3 g/l BSA |
| | Dirty condition: 3.0 g/l BSA + 3.0 ml/l human |
| | erythrocytes |
| Diluent for test | Distilled water |
| product A | |
| Temperature of | 37° C. ± 1° C., CO₂ incubator (5% CO₂) |
| incubation | |
| Test virus | SARS-COV-2 |
| Test virus: source | Tropical Infectious Disease Research & Education |
| | Centre (TIDREC), University of Malaya, Malaysia |
| Test virus: number | 2 |
| of passages | |
| Cell line | Vero E6 |
| Cell line: source | ATCC |
| Cell line: number of | Passages 22 |
| passages | |

### Suppression Assay

Suppression of virucidal activities of test product A and test product B was performed to accurately determine the virucidal activity of the test products at the specified contact time. Virucidal activity was suppressed by adding ice-cold DMEM+2% FBS to the test mixtures, and serially diluted 10-fold with cell culture medium. The suppression of virucidal activity of test products was assayed at 1 min exposure. As shown in Table 5, results from the suppression assay showed no difference in viral titers in the test mixtures compared to controls. This suggested that addition of cold media and serial dilution effectively suppressed the virucidal activity of the test products, resulting in no reduction in the viral titers.

TABLE 5

| | | | | Viral titer | |
|---|---|---|---|---|---|
| *Contact | | | Viral titer | [after | Difference |
| time | Interfering | Test | [control] | suppression] | in viral titer |
| (sec) | substance(s) | product | (TCID₅₀/ml) | (TCID₅₀/ml) | (TCID₅₀/ml) |
| 60 | 0.3 g/l BSA | A | 5.4 × 10⁵ | No inhibition | 0.00 |
| | | B | 5.4 × 10⁵ | No inhibition | 0.00 |
| 60 | 3.0 g/l BSA + | A | 5.4 × 10⁵ | No inhibition | 0.00 |
| | 3.0 ml/l human | B | 5.4 × 10⁵ | No inhibition | 0.00 |
| | erythrocytes | | | | |

*Undiluted mixture

### Virucidal Activity of Test Products

The test products A and B were tested against the test virus in accordance to the European Standard EN14476:2013/FprA1:2015 protocol. Manifestation of virus cytopathic effects in cell cultures was determined by comparing the test product-treated samples against that of the control-treated samples. The viral titer in the control-treated samples under clean and dirty conditions are 5.42×10⁵ TCID₅₀/ml. Both the test product A and test product B, when tested neat, achieved >5 log₁₀ reduction in viral titers when exposed for 1 min, 5 min and 10 min under both clean and dirty conditions as shown in Table 6.

TABLE 6

| | | Log₁₀ reduction in viral | | | | | |
|---|---|---|---|---|---|---|---|
| | | titers as compared to controls | | | | | |
| | Test | Clean condition | | | Dirty condition | | |
| Test virus | product | 1 min | 3 min | 10 min | 1 min | 3 min | 10 min |
| SARS-CoV-2 | A | >5.00 | >5.00 | >5.00 | >5.00 | >5.00 | >5.00 |
| | (undiluted) | | | | | | |
| | B | >5.00 | >5.00 | >5.00 | >5.00 | >5.00 | >5.00 |
| | (undiluted) | | | | | | |

The coating composition comprising titanium dioxide, silver ion and copper ion as active ingredients (test product A) and the coating composition comprising copper ion as active ingredients (test product B), when tested undiluted, demonstrated potent and rapid virucidal activity of ≥5 log₁₀ reduction in SARS-COV-2 (test virus) viral titer in 1 min under both clean and dirty conditions. These findings suggest that the disclosed coating compositions can kill 99.99% SARS-COV-2 in 1 min.

### Example 5

Efficacy Test of the Disclosed Coating Composition Against Salmonella typhimurium, Staphylococcus aureus and Candida albican

A disinfectant efficacy test is performed using a coating composition comprising titanium dioxide, silver oxide and copper sulfate as active ingredients (Test composition 1) and a disinfectant efficacy test is performed using an coating composition comprising tourmaline as active ingredient (Test composition 2) disclosed herein. The test is performed using in house method with reference to The United States Pharmacopeia (USP) 41 in which test microorganisms such as Salmonella typhimurium ATCC 14028, Staphylococcus aureus ATCC 25923 and Candida albican ATCC 10231 are introduced to the undiluted test compositions. The test parameters and results for test composition 1 and test composition 2 are shown in Table 7 and Table 8, respectively.

TABLE 7

| | | Initial | | Count of | | Percent kill of |
|---|---|---|---|---|---|---|
| | Contact | bacterial | | surviving test | | test |
| Test | time | load | | microorganism, | Log | microorganisms |
| Microorganism | (min) | (cfu/ml) | log₁₀ | cfu/ml (log₁₀) | reduction | (%) |
| Salmonella | 5 | 6.1 × 10⁸ | 8.79 | <10 (1.0) | >7.79 | >99.9999 |
| typhimurium | 60 | | | <10 (1.0) | >7.79 | >99.9999 |
| ATCC 14028 | | | | | | |
| Staphylococcus | 5 | 1.3 × 10⁹ | 9.11 | <10 (1.0) | >8.11 | >99.9999 |
| aureus | 60 | | | <10 (1.0) | >8.11 | >99.9999 |
| ATCC 25923 | | | | | | |
| Candida | 5 | 4.1 × 10⁶ | 6.61 | <10 (1.0) | >5.61 | >99.9999 |
| albican | | | | | | |
| ATCC 10231 | 60 | | | <10 (1.0) | >5.61 | >99.9999 |

TABLE 8

| | | Initial | | Count of | | Percent kill of |
|---|---|---|---|---|---|---|
| | Contact | bacterial | | surviving test | | test |
| Test | time | load | | microorganism, | Log | microorganisms |
| Microorganism | (min) | (cfu/ml) | log₁₀ | cfu/ml (log₁₀) | reduction | (%) |
| Salmonella | 5 | 6.1 × 10⁸ | 8.79 | <10 (1.0) | >7.79 | >99.9999 |
| typhimurium | 60 | | | <10 (1.0) | >7.79 | >99.9999 |
| ATCC 14028 | | | | | | |
| Staphylococcus | 5 | 1.3 × 10⁹ | 9.11 | <10 (1.0) | >8.11 | >99.9999 |
| aureus | 60 | | | <10 (1.0) | >8.11 | >99.9999 |
| ATCC 25923 | | | | | | |
| Candida | 5 | 4.1 × 10⁶ | 6.61 | <10 (1.0) | >5.61 | >99.9999 |
| albican | 60 | | | <10 (1.0) | >5.61 | >99.9999 |
| ATCC 10231 | | | | | | |

The results shown in Tables 7 and 8 show that the coating composition disclosed herein is capable of effectively killing bacteria such as Salmonella typhimurium, Staphylococcus aureus, and Candida albican killing after 5 minutes.

1.-8. (canceled)

9. A coating composition when used for surface disinfection comprising:
a nano-sized metal oxide selected from the group consisting of silver oxide, copper oxide, gold oxide, and any combination thereof;
an ultraviolet or fluorescent light-assisted photocatalyst selected from the group consisting of titanium oxide, titanium dioxide, tungsten oxide, tungsten trioxide, zinc oxide, and any combination thereof; and
an anti-static agent selected from antimony-doped tin oxide, quaternary ammonium salt, aliphatic amine, aliphatic amide, ester, or polyol.

10. The coating composition as claimed in claim 9 further comprising a binder, a liquid carrier, a surface additive, or any combination thereof.

11. The coating composition as claimed in claim 9, wherein the coating composition comprises from 0.01% to 30.0% by weight of the nano-sized metal oxide.

12. The coating composition as claimed in claim 9, wherein the nano-sized metal oxide has a particle size ranging from 5 nm to 50 nm.

13. The coating composition as claimed in claim 9, wherein the coating composition comprises 0.01% to 30.0% by weight of the ultraviolet or fluorescent light-assisted photocatalyst.

14. The antimicrobial coating composition as claimed in claim 9, wherein the coating composition comprises 0.01% to 30.0% by weight of the anti-static agent.

15. An article formed from the coating composition according to claim 9, and a substrate made of glass, metal, plastic, porcelain, rubber, paper, fabric, and any two or more of the combination thereof.
